(19) United States
(12) Patent Application Publication
(10) Pub. No.: US 2004/0077407 A1
(43) Pub. Date: Apr. 22, 2004

(54) Handheld device

(76) Inventor: Magnus Jandel, Upplands Vasby (SE)

Correspondence Address: YOUNG & THOMPSON, 745 SOUTH 23RD STREET 2ND FLOOR, ARLINGTON, VA, 22202

(21) Appl. No.: 10/204,699

(22) PCT Filed: Feb. 22, 2001
(86) PCT No.: PCT/SE01/00189

(30) Foreign Application Priority Data
Feb. 23, 2000 (SE) 0000584-3

(51) Int. Cl. A63F 13/00

(52) U.S. Cl. 463/36

(57) ABSTRACT

The invention relates to a hand-held device comprising a display (3), user input means (7, 8) enabling a user to control the function of the device, a processing unit (5), means (10, 5) for running at least one application on the device (1), at least one sensor (13) for recording at least one parameter related to a physiological function, which is indicative of the emotional state of a user operating the device, where the at least one sensor (13) comprises at least two electrodes (13a, 13b) and means (19) to measure a physical parameter representative of the current between the at least two electrodes (13a, 13b) for registering the electrical conductivity of a palm of a hand.

### TECHNICAL FIELD

The present invention relates to a hand-held gaming and/or communication device and more specifically to a hand-held gaming or communication device, which may be adapted to wireless communication

1. Description of Related Art

Such gaming devices are known from a plurality of vendors. Typically, they are used for chatting, or for playing games, and enable the user to input data. The data may be processed in the device and, in some applications, transmitted to one or more other users. The data may be displayed directly on the other user's communication device, or it may be used, for example, to update a multi-user game environment.

2. Problem of the Invention

The present invention is aimed at providing a qualitatively new feature to social communication using electronic devices, such as chatting or playing games.

### SUMMARY OF THE INVENTION

The invention achieves this by providing a hand-held device comprising a display, user input means enabling a user to control the function of the device, a processing unit, means for running at least one application on the device, at least one sensor for recording at least one parameter related to a physiological function, indicative of the emotional state of a user operating the device, where the at least one sensor comprises at least two electrodes and means to measure a physical parameter representative of the current between the at least two electrodes and for registering the electrical conductivity of a palm of a hand.

In this way, parameters indicative of the emotional state of the user of the device may be used to influence the function of the application, for example a game, running on the device. The conductivity of the skin of the user's hands, which is an indicator of emotional state, for example, of stress or excitement, may be used to influence the course of the application.

The application is preferably a social application, such as a chat program or a game involving two or more users, but it may also be a single user game or application.

Preferably, the device according to the invention further comprises means for changing the course of the application in dependence of the at least one parameter. In this way, for example, a game running on the device may be adapted to the registered stress level of the user.

Preferably, the device according to the invention also comprises transmission and receiving means, controlled by the processing unit, for transmitting information to and receiving information from, at least one other communication device. The transmission and receiving means are preferably adapted for wireless communication.

In this case the device preferably further comprises means for adapting the information transmitted by the transmission means in dependence of the at least one parameter recorded by the at least one sensor. The device may then also comprise means for changing the course of the application in dependence of information received by the receiving means. This enables interaction with other players or users in dependence of the emotional state of each user.

According to another preferred embodiment, the at least one sensor is adapted to register heart rate. The heart rate, which is also an indicator of a person's emotional state may then be used in the same way as the conductivity above.

Of course, both types of sensors, and other sensors, may be used in the same device.

### BRIEF DESCRIPTION OF THE DRAWINGS

In the following preferred embodiments of the invention will be described, with reference to the appended drawings, in which

FIG. 1 is a block diagram of a general communication device according to the invention.

### DETAILED DESCRIPTION OF EMBODIMENTS

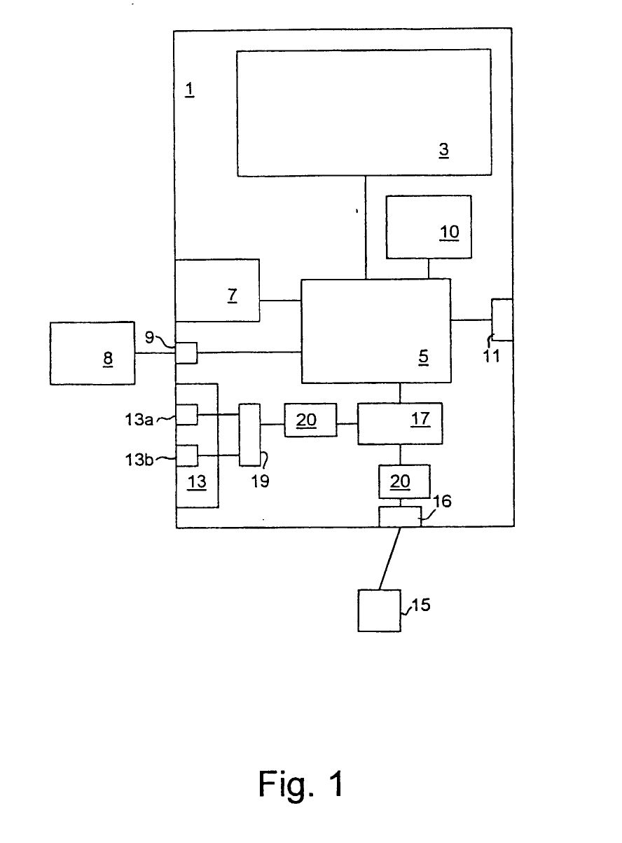

FIG. 1 shows a block diagram of a communication or gaming device I according to the invention. As common in the art, the communication device comprises a display 3 for displaying text and/or graphics to the user. The display is controlled by a processing unit 5. A user of the communication device can input data through one or more user input devices 7, 8 connected to the processing unit 5. FIG. 1 shows a keyboard 7 integrated in the communication device and a mouse 8, connected to a connector 9 of the communication device, as input devices. Joysticks and any other type of user controlled input device may also be used. Although FIG. 1 shows only one processing unit 5 which controls all other units, of course, several processing units could be used, for controlling different parts of the device, or for providing redundancy.

A memory unit 10 connected to the processing unit 5 comprises one or more applications and possibly other data as will be discussed below.

Preferably, the communication or gaming device 1 also comprises at least one transmitter/receiver unit 11, controlled by the processing unit 5, for communicating with a similar communication device operated by another user. The communication may take place directly between the communication devices or through a network, according to any known communication standard. Therefore, the transmitter/receiver unit 11 may be, for example, an IR port, a short-range radio transceiver, a transmitter/receiver according to any mobile telecommunications protocol. The device may comprise more than one transmitter/receiver unit to enable it to communicate according to several different protocols, for example an IR port for short-range communication and a transmitter/receiver for a cellular network for long-range communication.

According to the invention the communication device also comprises one or more sensors 13, 15 for recording parameters related to a physiological function, indicative of the emotional state of the user operating the communication device. The parameters registered by the sensor, or sensors, are converted from analogue to digital signals in an A/D converter 17 and evaluated in the processing unit 5 to generate a signal corresponding to the parameter recorded.

The physiological function may be, for example, the electrical conductivity in the skin of the hand holding the console. In this case, the sensor 13 comprises electrodes 13a, 13b in positions where the player's hands are in electrical contact with them. The communication device also comprises measuring means 19 for measuring currents that pass between the electrodes 13a, 13b.

Another function suitable for use according to the invention is the heart rate of the user. If the user becomes stressed, or excited, the heart rate will normally increase. The communication device of FIG. 1 also comprises a heart rate sensor 15 connected to a connector 16 of the communication device 1.

It will be understood that each of the sensors 13, 15 could be integrated in the communication device or connected through a connector, or by a wireless connection to the communication device. Between the measuring means 19 and the A/D converter 17 and/or the heart rate sensor 15 and the A/D converter 17 an amplifier may be arranged for amplifying the analogue signal before A/D conversion.

The sensors may be integrated in the communication device, in the positions where the user's hands or fingers will normally be, or the communication device may comprise input means for receiving information from the sensors. For example, to provide a more reliable indication of the user's heart rate, a sensor arranged to communicate with the communication device may be applied to the ear lobe of the user.

The parameter information obtained from the sensors 13, 15 may be used in different ways. The parameter information may be used to adapt the game to the level of stress of the player. If the player is bored, the game can be made more difficult. The parameter information may also be incorporated by the processing unit 5 in the signal transmitted to the other communication device or devices, to inform the user of the other communication device or devices about the emotional state of the user. In this case the emotional state of the player can be displayed by e.g. colour signatures. Skilled players can then use emotion signals to predict behaviour.

The values of the parameters mentioned, especially the skin conductivity, will depend significantly on the individual player. It may therefore be desirable to calibrate the device to the user. The simplest way of doing this will be to measure the heart rate and/or conductivity at rest and extrapolate a curve from the value found at rest. A more sophisticated way would be to measure the parameter at given points in time while the user was playing a game, while at the same points in time assessing the level of stress or excitement to produce a calibration curve for the user.

The memory unit 10 could store one or more personal calibration curves obtained as described above. One or more standard calibration curves could also be stored in the memory unit 10, so that a user could select the most suitable one.

1. A hand-held device comprising a display (3), user input means (7, 8) enabling a user to control the function of the device, a processing unit (5), means (10, 5) for running at least one application on the device (1), characterised by at least one sensor (13) for recording at least one parameter related to a physiological function, which is indicative of the emotional state of a user operating the device, the at least one sensor (13) comprises at least two electrodes (13a, 13b) and means (19) to measure a physical parameter representative of the current between the at least two electrodes (13a, 13b) and for registering the electrical conductivity of a palm of a hand.

2. A hand-held device according to any one of the preceding claims wherein the at least one application is a computer game.

3. A hand-held device according to claim 1 or 2, further comprising means (5) for changing the course of the application in dependence of the at least one parameter.

4. A hand-held device according to claim 1, 2 or 3, further comprising transmission and receiving means (11) controllable by the processing unit (5), for transmitting information to and receiving information from, at least one other communication device of essentially the same type as the hand-held device.

5. A hand-held device according to claim 4, further comprising means (5) for adapting the information transmitted by the transmission means (11) in dependence of the at least one parameter recorded by the at least one sensor.

6. A hand-held device according to claim 4 or 5, further comprising means (5) for changing the course of the application in dependence of information received by the receiving means (11).

7. A hand-held device according to any one of the claims 4, 5 or 6, wherein the transmission and receiving means (11) is adapted to wireless communication.

8. A hand-held device according to any one of the claims 4-7, wherein the application is a multi-user application, requiring communication between the device and at least one other device.

9. A hand-held device according to any one of the preceding claims, wherein the at least one sensor (15) is adapted to register heart rate.
